(19) United States
(12) Patent Application Publication
(10) Pub. No.: US 2026/0260151 A1
(43) Pub. Date: Sep. 3, 2026

(54) SYSTEMS AND METHODS FOR THE EXECUTION OF QUANTUM ALGORITHMS

(71) Applicant: Universal Quantum LTD, Brighton (GB)

(72) Inventors: Mark WEBBER, Brighton (GB); Harold GODWIN, Brighton (GB)

(21) Appl. No.: 19/347,526

(22) Filed: Oct. 1, 2025

Related U.S. Application Data
(63) Continuation of application No. PCT/GB2024/050910, filed on Apr. 3, 2024.

(30) Foreign Application Priority Data
Apr. 4, 2023 (GB) 2304988.5

(51) Int. Cl. G06N 10/60; G06N 10/20; G06N 10/40; G06N 10/70

(52) U.S. Cl. CPC G06N 10/60; G06N 10/20; G06N 10/40; G06N 10/70

(57) ABSTRACT

Proposed are schemes, solutions, concepts, designs, methods, and systems pertaining to the control of execution of a quantum algorithm on a quantum computer. Each of a plurality of secondary controllers may be associated with subsets of a plurality of logical qubits of the quantum computer. A primary controller may compile a quantum algorithm into logical qubit functions for execution on the logical qubits and prompt secondary controllers to execute logical qubit functions on respective subsets of logical qubits. The primary controller may have an abstracted control of the overall execution of the quantum algorithm by the selection of the logical qubit functions, while the secondary controllers may have control over precisely how the logical qubit functions are executed on the logical qubits (including error-correction, routing, etc.). Thus, problems associated with executing complex quantum algorithms involving a large number of qubits may be alleviated.

### CROSS-REFERENCE

This application is a continuation of International Application No. PCT/GB2024/050910 filed on Apr. 3, 2024, which claims the benefit of United Kingdom (GB) Patent Application No. GB 2304988.5, filed Apr. 4, 2023, each of which are incorporated herein in their entirety by reference.

### BACKGROUND

Quantum computing is based on the exploitation of quantum mechanical properties (e.g., superpositions and entanglement) of particles or matter in order to produce or alter data. Data is represented by quantum bits (qubits). Qubits are used in quantum algorithms consisting of a number of quantum logic gates to solve computational problems, where they are used for input/output and intermediate computations.

A physical qubit is an actual quantum implementation of a qubit. In some cases, individual physical qubits may not be stable enough to be able to encode information for sufficient length of time to be useful. Indeed, physical qubits may suffer from unwanted decoherence. Quantum computers implement logical qubits using many physical qubits to create an error-tolerant qubit. Thus, logical qubits may behave as specified in a quantum algorithm/circuit.

Furthermore, quantum error correction (QEC) is used in quantum computing to improve resilience of quantum information to errors from decoherence and other noise. In classical computing, redundancy is introduced to improve resilience to noise. However, copying quantum information is not possible due to the no-cloning theorem. Nevertheless, it is possible to spread the information of one logical qubit onto a highly entangled state of several physical qubits.

### SUMMARY

Quantum computers have demonstrated QEC primitives on 1-2 logical qubits, including memory experiments, single qubit operations, and logical CNOTs. Dynamic physical corrections have been performed in real time as a function of real-time (lookup table) decoders. With few logical qubits, pre-compilation of the entire quantum algorithm may be effective, with dynamic logic achieved by selecting precomputed paths. For example, for trapped ion quantum computers, ion-routing algorithms may be handled in a centralized pre-compiled manner, where a whole-device view is used.

A significant area of research is centered around the understanding that decoding becomes more challenging with increasing numbers of physical qubits per logical qubit, and so a heuristic method (such as minimum weight perfect matching) may need to be used eventually.

For a large-scale device, the algorithm may need to be run uninterrupted for many days and may involve hundreds of thousands of qubits. There may be problems with scaling up the current approach to managing and controlling a quantum computer at this scale, such as an exponential growth in circuit branch possibilities, routing algorithm complexity, and decoder outcomes.

There is therefore a need to provide improved quantum computing systems and methods for execution of quantum algorithms.

System and methods of the present disclosure may control of execution of a quantum algorithm on a quantum computer. In some cases, each of a plurality of secondary/second controllers are associated with subsets of a plurality of logical qubits of the quantum computer. A primary/first controller may compile a quantum algorithm into logical qubit functions for execution on the logical qubits and may prompt secondary/second controllers to execute logical qubit functions on respective subsets of logical qubits. The primary/first controller may compile logical qubit functions into a sequence of operations to be performed on logical qubits and may produce control signals for the operations to be executed. In some cases, the primary/first controller may have an abstracted control of the overall execution of the quantum algorithm by the selection of the logical qubit functions, while the secondary/second controllers may have control over precisely how the logical qubit functions are executed on the logical qubits (such as, for example, error-correction, routing, etc.). Systems and methods of the present disclosure may address problems associated with executing complex quantum algorithms involving a large number of qubits.

Systems and methods of the present disclosure may split control over the execution of the quantum algorithm into modular chunks of logical qubits. Each secondary/second controller is associated with a subset of logical qubits and may determine how to execute logical qubit's functions. The primary/first controller may have a more abstracted view, prompting secondary/second controllers to perform logical qubit functions in order to execute the quantum algorithm. Some cases, the primary/first controller may not have control over how the secondary controllers prompt execution of individual operations performed on logical qubits.

In some cases, the secondary controller may individually (e.g., without prompting) perform operations on the logical qubits, for example to perform error-correction in case of an unexpected failure (e.g., due to decoherence of associated physical qubits). As control of the logical qubits is split up, problems that arise due to scaling the number of logical qubits (e.g., routing, compiling, etc.) may be alleviated.

In an aspect, the present disclosure provides a system for controlling execution of a quantum algorithm on a quantum computer. The system may comprise: a first controller in communication with a plurality of second controllers, wherein the first controller is configured to transmit a set of instructions to the plurality of second controllers, wherein the set of instructions comprises a portion of a quantum algorithm to be implemented on one or more logical qubits associated with the plurality of second controllers, wherein an instruction within said set of instructions is configured to direct a second controller of the plurality of second controllers to compile the instruction into a sequence of operations to be executed on a plurality of physical qubits.

In some embodiments, the first controller is configured to compile the quantum algorithm into the set of instructions. In some embodiments, the set of instructions is configured to prompt a set of logical qubit functions on the one or more logical qubits. In some embodiments, the set of logical qubit functions comprises one or more of: a set of operations that enable a universal set of logical gates, a set of operations including a magic state distillation, a magic state consumption, a Clifford gate application, a syndrome extraction, and a logical measure.

In some embodiments, the first controller is not configured to provide a sequence of operations to be executed on a plurality of physical qubits. In some embodiments, the second controller is configured to control the one or more logical qubits associated with the second controller. In some embodiments, the first controller is configured to generate an assignment of a subset of the one or more logical qubits to be associated with each second controller in the plurality of second controllers. In some embodiments, the assignment is based at least in part on a distance between a logical qubit and a secondary controller. In some embodiments, the assignment is based at least in part on an even distribution of logical qubits amongst the plurality of second controllers.

In some embodiments, the second controller is configured to be associated with a predetermined subset of the one or more logical qubits. In some embodiments, the second controller is configured to be associated with the one or more logical qubits within a boundary. In some embodiments, the second controller is configured to locally detect and correct errors within the one or more logical qubits.

In some embodiments, the second controller comprises or is associated with a hardware, wherein the hardware is configured to provide the second controller with measurements of the logical qubits. In some embodiments, the hardware is configured to obtain the measurements directly from the logical qubits. In some embodiments, the hardware is configured to obtain the measurements from a downstream hardware. In some embodiments, the hardware is associated with a decoder. In some embodiments, the decoder is configured to process the measurements to determine whether there is an error or lack thereof in the one or more logical qubits or a physical qubit associated with the logical qubits. In some embodiments, the decoder is configured to generate a plurality of control signals to prompt a correction operator to be executed on a logical qubit or a monitor operator to track the logical qubits.

In some embodiments, the second controller is configured to receive real time information from a source other than the primary controller, and wherein the second controller is configured to dynamically compile the instruction in the plurality of instructions based on real time information. In some embodiments, the real time information is based at least in part on a fill factor of trapped qubits. In some embodiments, the primary controller and secondary controller collectively speed up compilation of the instruction by greater than order 2ⁿ wherein n is a number of logical qubits.

In some embodiments, an operation in the sequence of operations comprises a qubit manipulation. In some embodiments, the qubit manipulation comprises a physical operation of physical qubits associated with the logical qubits. In some embodiments, the physical operation includes one or more of: an ion shuttling, a sympathetic cooling, a single qubit gate operation, a two-qubit gate operation, a measurement, and a real time conditional quantum gate operation.

In some embodiments, the second controller is configured to generate a plurality of control signals, wherein the control signal is configured to execute the sequence of operations on the one or more logical qubits. In some embodiments, the control signal is configured to act directly upon the one or more logical qubits. In some embodiments, the control signal is configured to prompt a hardware or software to execute the sequence of operations. In some embodiments, the second controller is configured to maintain contextual knowledge of the one or more logical qubits.

In some embodiments, a master controller is configured to be connected to a plurality of the first controllers. In some embodiments, the master controller is configured to divide a master algorithm into a plurality of quantum algorithms, wherein the master controller is configured to transmit a quantum algorithm in the plurality of quantum algorithms to a first controller to be compiled. In some embodiments, each second controller in the plurality of secondary controller is associated with a memory, wherein the memory is configured to provide each second controller with a list, wherein each second controller is configured to compile the list into a sequence of operations.

In another aspect, the present disclosure provides a system for controlling execution of a quantum algorithm on a quantum computer. The system may comprise: a first controller in communication with a plurality of second controllers, wherein the first controller is configured to transmit a set of instructions to the plurality of second controllers, wherein the set of instructions comprises a portion of a quantum algorithm to be implemented on one or more logical qubits associated with the plurality of second controllers, wherein an instruction within said set of instruction is configured to direct a second controller of the plurality of second controllers to implement a sequence of operations on one or more logical qubits associated with the second controller based at least in part on the set of instructions, wherein an operation in the sequence of operations comprises at least a qubit movement operation on a physical qubit associated with the second controller.

In some embodiments, the first controller is configured to compile the quantum algorithm into the set of instructions. In some embodiments, the set of instructions is configured to prompt a set of logical qubit functions on the one or more logical qubits. In some embodiments, the set of logical qubit functions comprises one or more of: a set of operations that enable a universal set of logical gates, a set of operations including a magic state distillation, a magic state consumption, a Clifford gate application, a syndrome extraction, and a logical measure.

In some embodiments, the first controller is not configured to provide a sequence of operations to be executed on a plurality of physical qubits. In some embodiments, the second controller is configured to control the one or more logical qubits associated with the second controller. In some embodiments, the first controller is configured to generate an assignment of the one or more logical qubits to be associated with each second controller in the plurality of second controllers. In some embodiments, the assignment is based at least in part on a distance between a logical qubit and a secondary controller when making the assignment. In some embodiments, the assignment is based at least in part on an even distribution of logical qubits amongst the plurality of second controllers when making the assignment.

In some embodiments, the second controller is configured to be associated with a predetermined subset of the one or more logical qubits. In some embodiments, the second controller is configured to be associated with the one or more logical qubits within a boundary. In some embodiments, the second controller is configured to locally detect and correct errors within the one or more logical qubits. In some embodiments, the second controller comprises or is associated with a hardware, wherein the hardware is configured to provide the second controller with measurements of the logical qubits. In some embodiments, the hardware is configured to obtain the measurements directly from the logical qubits. In some embodiments, the hardware is configured to obtain the measurements from a downstream hardware. In some embodiments, the hardware is associated with a decoder. In some embodiments, the decoder is configured to process the measurements to determine whether there is an error or lack thereof in the one or more logical qubits or a physical qubit associated with the logical qubits. In some embodiments, the decoder is configured to generate a plurality of control signals to prompt a correction operator to be executed on a logical qubit or a monitor operator to track the logical qubits.

In some embodiments, the second controller is configured to receive real time information from a source other than the primary controller, and wherein the second controller is configured to dynamically compile the instruction in the plurality of instructions based on real time information. In some embodiments, the real time information is based at least in part on a fill factor of trapped qubits. In some embodiments, the primary controller and secondary controller collectively speed up compilation of the instruction by greater than order 2ⁿ wherein n is a number of logical qubits.

In some embodiments, an operation in the sequence of operations comprises a qubit manipulation. In some embodiments, the qubit manipulation comprises a physical operation of physical qubits associated with the logical qubits. In some embodiments, the physical operation includes one or more of: an ion shuttling, a sympathetic cooling, a single qubit gate operation, a two-qubit gate operation, a measurement, and a real time conditional quantum gate operation.

In some embodiments, the second controller is configured to generate a plurality of control signals, wherein the control signal is configured to execute the sequence of operations on the one or more logical qubits. In some embodiments, the control signal is configured to act directly upon the one or more logical qubits. In some embodiments, the control signal is configured to prompt a hardware or software to execute the sequence of operations. In some embodiments, the second controller is configured to maintain contextual knowledge of the one or more logical qubits.

In some embodiments, a master controller is configured to be connected to a plurality of the first controllers. In some embodiments, the master controller is configured to divide a master algorithm into a plurality of quantum algorithms, wherein the master controller is configured to transmit a quantum algorithm in the plurality of quantum algorithms to a first controller to be compiled. In some embodiments, each second controller in the plurality of secondary controller is associated with a memory, wherein the memory is configured to provide each second controller with a list, wherein each second controller is configured to compile the list into a sequence of operations.

In another aspect, the present disclosure provides a system for controlling execution of a quantum algorithm on a quantum computer. The system may comprise: a first controller in communication with a plurality of second controllers, wherein the first controller is configured to transmit a set of instructions to the plurality of second controllers, wherein the set of instructions comprises a portion of a quantum algorithm to be implemented on one or more logical qubits associated with the plurality of second controllers, wherein an instruction within the set of instructions is configured to direct a second controller of the plurality of second controllers to implement a sequence of operations on one or more logical qubits associated with the second controller based at least in part on the set of instructions, wherein the one or more logical qubits comprise trapped ion qubits.

In some embodiments, the one or more logical qubits are based on qubits capable of being physically translated during the quantum algorithm. In some embodiments, the first controller is configured to compile the quantum algorithm into the set of instructions. In some embodiments, the set of instructions is configured to prompt a set of logical qubit functions. In some embodiments, the set logical qubit functions comprises one or more of: a set of operations that enable a universal set of logical gates, a set of operations including a magic state distillation, a magic state consumption, a Clifford gate application, a syndrome extraction, and a logical measure.

In some embodiments, the first controller is not configured to provide a sequence of operations to be executed on a plurality of physical qubits. In some embodiments, the second controller is configured to control the one or more logical qubits associated with the second controller. In some embodiments, the first controller is configured generate an assignment of the one or more logical qubits to be associated with each second controller in the plurality of second controllers. In some embodiments, the assignment is based at least in part on a distance between a logical qubit and a secondary controller when making the assignment. In some embodiments, the assignment is based at least in part on an even distribution of logical qubits amongst the plurality of second controllers when making the assignment.

In some embodiments, the second controller is configured to be associated with a predetermined subset of the one or more logical qubits. In some embodiments, the second controller is configured to be associated with the one or more logical qubits within a boundary. In some embodiments, the second controller is configured to locally detect and correct errors within the one or more logical qubits. In some embodiments, the second controller comprises or is associated with a hardware, wherein the hardware is configured to provide the second controller with measurements of the logical qubits. In some embodiments, the hardware is configured to obtain the measurements directly from the logical qubits. In some embodiments, the hardware is configured to obtain the measurements from a downstream hardware. In some embodiments, the hardware is associated with a decoder. In some embodiments, the decoder is configured to process the measurements to determine whether there is an error or lack thereof in the one or more logical qubits or a physical qubit associated with the logical qubits. In some embodiments, the decoder is configured to generate a plurality of control signals to prompt a correction operator to be executed on a logical qubit or a monitor operator to track the logical qubits.

In some embodiments, the second controller is configured to receive real time information from a source other than the primary controller, and wherein the second controller is configured to dynamically compile the instruction in the plurality of instructions based on real time information. In some embodiments, the real time information is based at least in part on a fill factor of trapped qubits. In some embodiments, the primary controller and secondary controller collectively speed up compilation of the instruction by greater than order 2ⁿ wherein n is a number of logical qubits.

In some embodiments, an operation in the sequence of operations comprises a qubit manipulation. In some embodiments, the qubit manipulation comprises a physical operation of physical qubits associated with the logical qubits. In some embodiments, the physical operation includes one or more of: an ion shuttling, a sympathetic cooling, a single qubit gate operation, a two-qubit gate operation, a measurement, and a real time conditional quantum gate operation.

In some embodiments, the second controller is configured to generate a plurality of control signals, wherein the control signal is configured to execute the sequence of operations on the one or more logical qubits. In some embodiments, the control signal is configured to act directly upon the one or more logical qubits. In some embodiments, the control signal is configured to prompt a hardware or software to execute the sequence of operations. In some embodiments, the second controller is configured to maintain contextual knowledge of the one or more logical qubits.

In some embodiments, a master controller is configured to be connected to a plurality of the first controllers. In some embodiments, the master controller is configured to divide a master algorithm into a plurality of quantum algorithms, wherein the master controller is configured to transmit a quantum algorithm in the plurality of quantum algorithms to a first controller to be compiled. In some embodiments, each second controller in the plurality of secondary controller is associated with a memory, wherein the memory is configured to provide each second controller with a list, wherein each second controller is configured to compile the list into a sequence of operations.

In another aspect, the present disclosure provides a system (100) for controlling execution of a quantum algorithm on a quantum computer (105). The system may comprise a primary controller (110) in communication with a plurality of secondary controllers (120), wherein the primary controller is configured to: compile the quantum algorithm into a plurality of logical qubit functions to be executed on a plurality of logical qubits; and transmit an instruction to each of a plurality of secondary controllers, each instruction prompting execution of one of the plurality of logical qubit functions on a subset of the plurality of logical qubits associated with the secondary controller; and wherein each of the plurality of secondary controllers is configured to: receive the instruction prompting execution of the logical qubit function from the primary controller; compile the instruction into a sequence of operations, each operation to be executed on one or more of the logical qubits associated with the secondary controller; and generate a plurality of control signals, each control signal prompting one of the plurality of operations to be executed on the logical qubits.

In some embodiments, the plurality of logical qubit functions is selected from a set of operations that enable a universal set of logical gates, the set of operations including a magic state distillation, a magic state consumption, a Clifford gate application, a syndrome extraction, and a logical measure. In some embodiments, each of the operations in the sequence of operations describe a manipulation to be applied to the logical qubits. In some embodiments, the manipulation to be applied comprises a sequence of physical operations applied to physical qubits associated with the logical qubits. In some embodiments, each of the physical operations includes at least one of an ion shuttling, a sympathetic cooling, a single qubit gate operation, a two-qubit gate operation, a measurement, and a real time conditional quantum gate operation. In some embodiments, the system further comprises a memory (122) associated with each of the plurality of secondary controllers (120), the memory configured to store a list comprising a plurality of instructions, each having an associated sequence of operations, and wherein each of the plurality of secondary controllers is configured to compile the instruction into the sequence of operations based on the list.

In some embodiments, the plurality of secondary controllers (120) is further configured to transmit the control signal to one of a plurality of processors (130) for execution of the operation to be performed on the logical qubits. In some embodiments, ach of the plurality of secondary controllers (120) comprises a decoder (124) configured to: obtain a set of check operator measurements of the logical qubits associated with the secondary controller; process the set of check operator measurements to determine a correction operator for removing error of the logical qubits or a monitor operator for tracking the logical qubits; and generate a plurality of control signals prompting the correction operator to be executed on the logical qubits or the monitor operator to track the logical qubits.

In some embodiments, the subset of logical qubits associated with each secondary controller (120) is one of a predetermined subset of logical qubits, or a subset of logical qubits in a predetermined area of the quantum computer (105). In some embodiments, the primary controller (110) is further configured, for each of the secondary controllers (120), to assign a subset of the plurality of logical qubits to the secondary controller. In some embodiments, the quantum computer (105) is a trapped ion quantum computer. In some embodiments, each secondary controller (120) is further configured to: monitor physical operations performed on the logical qubits associated with the secondary controller in order to detect ion-loss corresponding to one of the logical qubits; responsive to detecting ion-loss, compile a correction instruction for handling the ion-loss into a sequence of correction operations, each correction operation to be executed on the logical qubit; and generate a plurality of control signals, each control signal prompting one of the plurality of correction operations to be executed on the logical qubit. In some embodiments, the system further comprises a master controller (140) in communication with a plurality of the primary controllers (110), the master controller configured to: obtain a master quantum algorithm; divide the master quantum algorithm into a plurality of quantum algorithms, each quantum algorithm assigned to a different primary controller; and transmit an instruction to each of the plurality of primary controllers, each instruction prompting execution of one of the quantum algorithms on the plurality of logical qubits.

In another aspect, the present disclosure provides a method (300) for controlling execution of a quantum algorithm on a quantum computer. The method may comprise: compiling (310), by a primary controller, the quantum algorithm into a plurality of logical qubit functions to be executed on a plurality of logical qubits; transmitting (320), by the primary controller, an instruction to each of a plurality of secondary controllers, each instruction prompting execution of one of the plurality of logical qubit functions on a subset of the plurality of logical qubits associated with the secondary controller; receiving (330), by the secondary controller, the instruction prompting execution of the logical qubit function from the primary controller; compiling (340), by the secondary controller, the instruction into a sequence of operations, each operation to be executed on one or more of the logical qubits associated with the secondary controller; and generating (350), by the secondary controller, a plurality of control signals, each control signal prompting one of the plurality of operations to be executed on the logical qubits.

In another aspect, the present disclosure provides a computer program comprising computer program code which when executed on a computer is configured to implement the method (300).

In another aspect, the present disclosure provides a method for controlling execution of a quantum algorithm on a quantum computer. The method may comprise: providing a first controller in communication with a plurality of second controllers; at the first controller, transmitting a set of instructions to the plurality of second controllers, wherein the set of instructions comprises a portion of a quantum algorithm to be implemented on one or more logical qubits associated with the plurality of second controllers, wherein an instruction within said set of instructions is configured to direct a second controller of the plurality of second controllers to compile the instruction into a sequence of operations to be executed on a plurality of physical qubits. In another aspect, the present disclosure provides a computer program comprising computer program code which when executed on a computer is configured to implement the method.

In another aspect, the present disclosure provides a method for controlling execution of a quantum algorithm on a quantum computer. The method may comprise: providing a second controller of a plurality of second controllers in communication with a first controller; at the second controller, receiving an instruction from a set of instructions from the first controller, wherein the set of instructions comprises a portion of a quantum algorithm to be implemented on one or more logical qubits associated with the plurality of second controllers; and at the second controller, compiling the instruction into a sequence of operations to be executed on a plurality of physical qubits. In another aspect, the present disclosure provides a computer program comprising computer program code which when executed on a computer is configured to implement the method.

According to another aspect there is provided a system for controlling execution of a quantum algorithm on a quantum computer, the system comprising a primary controller in communication with a plurality of secondary controllers, the primary controller configured to: compile the quantum algorithm into a plurality of logical qubit functions to be executed on a plurality of logical qubits; transmit an instruction to each of a plurality of secondary controllers, each instruction prompting execution of one of the plurality of logical qubit functions on a subset of the plurality of logical qubits associated with the secondary controller; and each of the plurality of secondary controllers configured to: receive the instruction prompting execution of the logical qubit function from the primary controller; compile the instruction into a sequence of operations, each operation to be executed on one or more of the logical qubits associated with the secondary controller; and generate a plurality of control signals, each control signal prompting one of the plurality of operations to be executed on the logical qubits.

In an embodiment, the plurality of logical qubit functions may be selected from a set of operations that enable a universal set of logical gates. The set of operations may include a magic state distillation, a magic state consumption, a Clifford gate application, a syndrome extraction, and a logical measure. In another embodiment, each of the operations in the sequence of operations describe a manipulation to be applied to the logical qubits. In a further embodiment, the manipulation to be applied may comprise a sequence of physical operations applied to physical qubits associated with the logical qubits. In yet another embodiment, each of the physical operations may include at least one of an ion shuttling, a sympathetic cooling, a single qubit gate operation, a two-qubit gate operation, a measurement, and a real time conditional quantum gate operation.

In some embodiments, the system may further comprise a memory associated with each of the plurality of secondary controllers, the memory configured to store a list comprising a plurality of instructions, each having an associated sequence of operations. In this case, each of the plurality of secondary controllers may be configured to compile the instruction into the sequence of operations based on the list.

In additional embodiments, the plurality of secondary controllers may be further configured to transmit the control signal to one of a plurality of processors for execution of the operation to be performed on the logical qubits.

In some embodiments, each of the plurality of secondary controllers may comprise a decoder configured to: obtain a set of check operator measurements of the logical qubits associated with the secondary controller; process the set of check operator measurements to determine a correction operator for removing error of the logical qubits or a monitor operator for tracking the logical qubits; and generate a plurality of control signals prompting the correction operator to be executed on the logical qubits or the monitor operator to track the logical qubits.

In other embodiments, the subset of logical qubits associated with each secondary controller may be one of a predetermined subset of logical qubits, or a subset of logical qubits in a predetermined area of the quantum computer.

Additionally, in some embodiments, the primary controller may be further configured, for each of the secondary controllers, to assign a subset of the plurality of logical qubits to the secondary controller.

In some embodiments, the quantum computer is a trapped ion quantum computer.

Furthermore, in some embodiments, each secondary controller may be further configured to: monitor physical operations performed on the logical qubits associated with the secondary controller in order to detect ion-loss corresponding to one of the logical qubits; responsive to detecting ion-loss, compile a correction instruction for handling the ion-loss into a sequence of correction operations, each correction operation to be executed on the logical qubit; and generate a plurality of control signals, each control signal prompting one of the plurality of correction operations to be executed on the logical qubit.

Moreover, the system in some embodiments may further comprise a master controller in communication with a plurality of the primary controllers, the master controller configured to: obtain a master quantum algorithm; divide the master quantum algorithm into a plurality of quantum algorithms, each quantum algorithm assigned to a different primary controller; and transmit an instruction to each of the plurality of primary controllers, each instruction prompting execution of one of the quantum algorithms on the plurality of logical qubits.

According to another aspect of the invention there is provided a method for controlling execution of a quantum algorithm on a quantum computer, comprising: compiling, by a primary controller, the quantum algorithm into a plurality of logical qubit functions to be executed on a plurality of logical qubits; transmitting, by the primary controller, an instruction to each of a plurality of secondary controllers, each instruction prompting execution of one of the plurality of logical qubit functions on a subset of the plurality of logical qubits associated with the secondary controller; receiving, by the secondary controller, the instruction prompting execution of the logical qubit function from the primary controller; compiling, by the secondary controller, the instruction into a sequence of operations, each operation to be executed on one or more of the logical qubits associated with the secondary controller; and generating, by the secondary controller, a plurality of control signals, each control signal prompting one of the plurality of operations to be executed on the logical qubits.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates an example system for controlling the execution of quantum algorithms on a quantum computer according to an aspect of the present disclosure;

FIG. 2 illustrates another example of a system for controlling the execution of quantum algorithms on a quantum computer in accordance with the present disclosure; and

FIG. 3 is a flow diagram providing steps in an example method.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

The present disclosure provides systems and methods for controlling execution of a quantum algorithm (e.g., a quantum circuit) on a quantum computer. For example, the systems and methods of the present disclosure may decentralize control of execution of a quantum algorithm to many modular components (e.g., secondary controllers, a plurality of second controllers, a second controller, etc.) which may be responsible for a finite number of logical qubits. In some cases, the finite number of logical qubits may be a number of qubits which is smaller than a total of number of qubits a quantum computing systems. In some case, the modular components may be controlled by another component (e.g., a primary controller, a plurality of first controllers, a first controller, etc.).

Among various advantages, problems associated with scaling a quantum algorithm to be associated with a large number of logical qubits, and/or having a long run time can be overcome using a distributed or modular architecture. Systems and methods of the present disclosure may split control of the quantum computer into modular chunks, each modular chunk corresponding to a subset of logical qubits. As control of the logical qubits is split up, problems that arise due to scaling the number of logical qubits (e.g., routing, compiling, etc.) may be reduced.

In some cases, a quantum algorithm may be compiled into a number of logical qubit functions by a primary controller. A logical qubit may be a general concept of the information carrying capacity of a qubit, which may in practice be represented by a number of physical qubits. A physical qubit may be a physical embodiment of a qubit. For example, a photonic qubit, a trapped ion qubit, a Josephson junction qubit, or any other type of qubit. A primary controller may be a central controller. In some cases, a primary controller may be a “master controller.” A primary controller may be a first controller or a plurality of first controllers.

The primary or first controller may prompt secondary controllers or a plurality of second controllers or a second controller to execute logical qubit functions. The secondary controllers may be dispersed. The secondary controllers may be distributed. The primary/first controller may control the secondary/second controllers without necessarily dictating how to perform the logical qubit functions, and/or knowing how they are performed by the secondary/second controllers. Each secondary/second controller may interpret a received logical qubit function and determines a sequence of operations to be performed on individual (or small numbers of) logical qubits to which they are associated. In some cases, the second controller may have autonomous functionality relative to the first controller.

In some cases, the primary/first controller may receive an instruction to run the quantum computer to execute a (potentially large) quantum algorithm. The quantum algorithm may be split into a number smaller individual processes that can be performed on a small number of logical qubits. Each small process may be given to a secondary controller, which may determine how to actually implement the process. For example, the secondary/second controller may be prompted to perform a smaller part of the algorithm, and may individually determine how to perform other, more local, processes such as decoding and routing.

In some cases, signals containing information such as ion-loss and quantum error information may be fed up to the secondary controller and the control signals may be modified accordingly, handled in a decentralized manner. For example, in an error correction protocol information about the qubit, such as qubit loss, a bit flip, a phase flip, etc. may be directed up to the primary/first controller. In some cases, the secondary/second controller may receive information from hardware directly responsible for interactions with qubits (e.g., hardware lower in a hierarchical stack) and use such information to alter a response to a received logical qubit function. By way of explanation, for a large-scale device, the quantum algorithm may be run uninterrupted for many days. The quantum algorithm may also involve upwards of 100s of thousands of qubits.

Systems and methods of the present disclosure may improve upon methods and systems in which management and control of a quantum computer is handled centrally. In other words, the control and manipulation of qubits is handled by a single entity. Scaling this approach to managing a quantum computer for a quantum algorithm that runs for many days and associated with many qubits may lead to many problems, including, for example, (i) circuit branch possibilities grow, in a worst case scenario, at a rate of O(2ⁿ), so pre-compiling the quantum circuits may not possible in some circumstances (this is because potentially vast amounts of memory are used to hold the compiled result, and time-taken to pre-compile every possible version of the circuit may be impractical); and (ii) possible outcomes of a decoder can grow with O(2ⁿ), and run-time may be linearly with n. Put another way, with an increasing numbers of qubits, the fastest decoding algorithms run times may increase with slightly more than the square of the code distance, but the available time to do the processing may not be dependent on qubit number. Further, (iii) a bandwidth for control signals scales at least linearly with n. Even if the problems in (i) and (ii) could be solved by utilizing clusters of processors and large databanks, the data and control signals is subsequently delivered to the quantum computer. As each qubit may use its own individual control signals and be measured by its own individual sensor connections, the bandwidth use may grow linearly with qubit number. At large scales, this bandwidth may exceed the available bandwidth of data connection protocols for presently exploited qubit control methods. Further, (iv) using a whole device view, (and depending on methodology) routing algorithms complexity may grow as much as O(2ⁿ). This makes real time compilation challenging, especially for large qubit numbers. Further (v) various error events (e.g., qubit loss, a bit flip error, a phase flip error) increase at least with n, meaning that very rare failures on current quantum computers may become virtual certainties for large numbers of qubits. In an example, for trapped ion quantum computers, ion loss may occur occasionally. This may be considered a rare event for smaller quantum computers, and so it is possible to precompute a recovery branch or abandon a shot if an ion is found to have been lost. However, with 1 million ions, and multi-day runtimes, the chance of ion loss may approach 100%. It may not be possible to abandon a shot that loses an ion, and precomputation of the branches may be unmanageable at this scale without considering qubit loss.

Systems and methods of the present disclosure propose decentralization of hardware and software used to control execution of a quantum algorithm in order to address at least some of the above listed challenges. Systems and methods of the present disclosure propose self-contained, modular, functional components (e.g., secondary/second controllers) which each handle a small number of logical qubits. Secondary/second controllers may be controlled/managed by a central, primary controller with a whole-device view. In some cases, the primary/first controller may not know the details of internal functions of the secondary controller.

In some cases, a secondary/second controller may be pre-configured to perform a particular sequence of operations on a subset of logical qubits upon receiving an instruction to perform a logical qubit function. The primary/first controller may know when to instruct the secondary controller to perform the logical qubit function but may not hold knowledge of what specific steps make up the logical qubit function.

In some examples, a logical qubit function may be a syndrome extraction. A syndrome extraction may be a series of physical 2-qubit interactions and measurement operations which form a portion of an error correction procedure. The measurement operations may be analyzed, and the analysis may lead to suggested corrections on a logical qubit at the physical qubit. A logical qubit function may comprise a set of operations that may be implemented by a compiler which runs with a decoder. In some cases, the logical qubit function may be implemented in conjunction with classical processing and branch selection. In some cases, a secondary controller is capable of performing the syndrome extraction autonomously, and the primary controller may prompt the secondary controller to perform the syndrome extraction. In some cases, the primary controller may not comprise an indication of the method or results. In some cases, the secondary controller may privately decide to perform the syndrome extraction on its own accord (e.g., at a regular cadence) without a control signal from the primary/first controller.

In some cases, the set of qubits may comprise subsets of qubits. In some cases, the assigned/associated subset of logical qubits for each secondary controller may be determined with reference to physical device or area boundaries, or by grouping a set of physical or logical qubits. The selection may depend on the given architecture of the quantum computer. The subsets of qubit may, for example, relate to boundaries between modules of a trapped ion quantum computer.

In some cases, modular boundaries may be applied to control hardware, software and memory of the quantum computer, hardware accelerated processing units, and physical or logical qubits. Boundaries need not be the same (or even exist) for each of these areas, nor are they required to remain fixed for any length of time.

In some examples, each secondary controller may be designed to have a specific logical qubit function. A logical qubit function may comprise, for example, a magic state distillation, a magic state consumption, a Clifford gate application, syndrome extraction circuits, or logical measures. In some cases, secondary controllers may be connected to each other and to the primary controller with minimal or a reduced number of interactions.

A reduced number of interaction may reduce many of the challenges of scaling. In an example, if each secondary controller (as compilers) may interact with a small and finite number of logical qubits, the branching possibilities may be limited, and the runtime and complexity for the secondary controller acting as a compiler may be limited. In an example, if each secondary controller (as decoders) may decode results from a small number of qubits, the runtime and computation complexity may be controlled. In an example, if control signals for performing operations on the logical qubits are generated internally to the secondary controller, signals may control a small number of logical qubits, and the bandwidth may be reduced to a manageable size. In an example, the ion routing problem may be decentralized more efficient, for example, if the ions are routed in a dispersed manner by each secondary controller. In some cases, Decongestion may be handled at a local level, but ions may be able to retain some simple global information, like the final destination, such as through interaction with the first/primary controller. In some cases, ion specific global information may be passed from one decentralized routing compiler (e.g., adjacent secondary controllers) to another, overcoming complexity of large-scale routing problems by a central controller. In an example, if a smaller number of logical qubits are associated with the secondary controller, the high-level algorithm abstraction (handled by the primary controller) and errors (e.g., qubit loos, bit flip errors, phase flip error, or other errors) may be handled by the secondary controller(s).

Systems and methods of the present disclosure may provide a quantum algorithm which may be handled from top (abstract logical operations) to bottom (physical control of hardware) using a tiered approach, varying with regards to how much is precomputed, and centralized.

Systems and methods of the present disclosure provide processes for management and coordination of quantum algorithms.

At an operation, a process for management of a quantum algorithm may comprise compiling a quantum algorithm destined for logical qubits offline into a native gate set of the logical qubits. At an operation, a process for management of a quantum algorithm may comprise planning out the usage of the quantum device with another offline computation. A planning operation may comprise determining a size of the data block, a number and location of magic state distillation factories, and a routing spaces.

At an operation, a process for management of a quantum algorithm may comprise pre-computing the quantum algorithm down to logical qubit operations. The pre-computing may comprise a timing (ordering) of logical qubit operations and logical qubit interactions (movement).

At an operation, a process for management of a quantum algorithm may comprise broadcasting to the secondary/second controller in near real time the first step(s) of the quantum algorithm from the primary controller. In response to the broadcasting, the secondary/second controllers may compile associated movement and operations on logical/physical qubits in a decentralized manner.

At an operation, a process for management of a quantum algorithm may comprise compiling the quantum algorithm such that the algorithm is ready for execution prior to the completion of the current step(s).

At an operation, a process for management of a quantum algorithm may comprise offline pre-compilation of secondary controller-level specific routing paths, repeated patterns (e.g., error correction rounds), magic state distillation primitives, etc. Offline pre-compilation may be used within the real-time compilation to minimize duplication of effort. In some cases, the secondary controllers may comprise a handful of different designs, such that a single pre-compilation result may be usable across multiple secondary controllers (e.g., some controllers act as decoders, others as compilers, etc.).

At an operation, a process for management of a quantum algorithm may comprise tracking and rectifying localized (to the secondary controllers) physical operations, which may be dependent on mid-circuit measurements, and ion-loss internally to each secondary controller. In some cases, the secondary controllers may be capable of decentralized real time compilation. The primary controller may not need to instruct the module to perform these corrections, as they may be handled autonomously as part of the fulfilment of the abstracted instructions from the primary controller.

In some examples, systems and methods of the present disclosure may aim to provide a de-centralized, modularized (based on subsets of logical qubits) decoders.

In some cases, real-time or near real-time decoding error syndromes may be useful for functional error correction. In some cases, dedicated field programmable gate-array (FPGA) hardware may be used to process the error syndromes to estimate a likelihood distribution of physical errors. In some cases, the decoding problem may be computationally intensive. For example, in the case of minimum weight perfect matching (a candidate decoding scheme applicable to many error correction codes including the surface code) the computational difficulty may scale with the code distance, as O(d^{2.1}). The problem of decoding multiple logical qubits may be decentralized in that the decoding of each logical qubit may be independent of the others. In some cases, it may be beneficial to have real-time or near-real time decoding in order to process the error syndromes quickly (relative to a rate of physical operations). In some cases, by decentralizing the decoding problem, multiple decoders (e.g., secondary controllers acting as decoders) may be used such that each decoder may be responsible for a variable percentage of the total quantum computing device. In some cases, each decoder may be responsible for a variable percentage of the number of logical qubits or an area of the device corresponding to logical qubits. In some cases, the number of secondary controllers as decoders may then be chosen to reach the desired processing frequency.

The present disclosure provides at least two methods for portioning out the responsibilities of each decoder (e.g., secondary controllers as decoders) following this modular controlling approach.

In some examples, each decoder/secondary controller may be responsible for a subset of logical qubits which may not be dependent on the location of the logical qubits in the quantum computer. Logical qubits may be moved around the device, even across modules, and in an example scheme, they may be tied to a particular decoder/secondary controller regardless of the movement. As such, the transfer of syndrome information may be managed towards the decoder/secondary controller that corresponds to each particular logical qubit.

In some examples, each decoder/secondary controller may be responsible for a specific area of the quantum computing device, regardless of which logical qubits exist there. In some examples, the management of the transfer of responsibilities between secondary controllers/decoders may be based on the physical movement of ions across the quantum computing device.

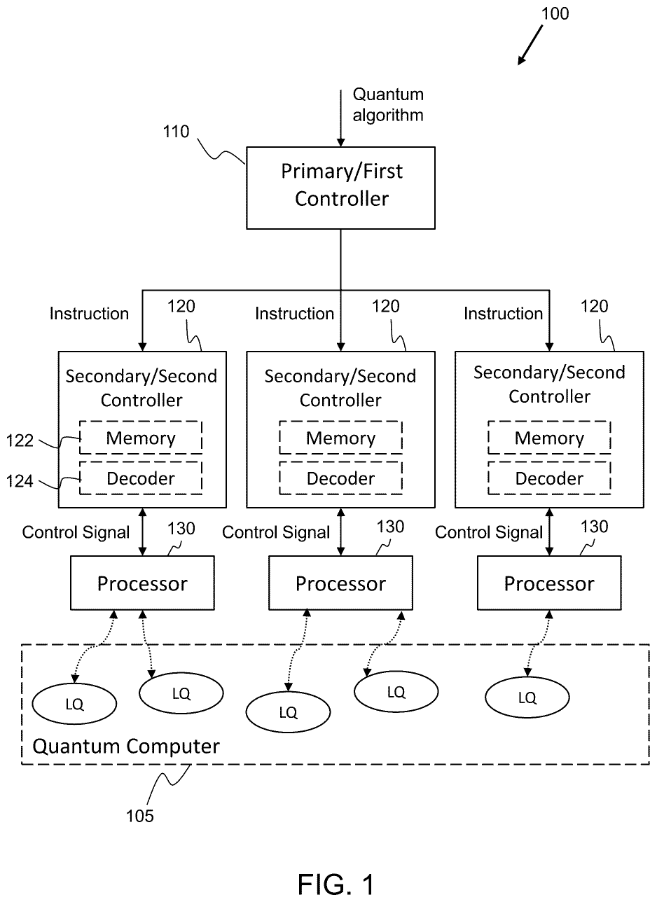

FIG. 1 illustrates an example of a system 100 for controlling the execution of quantum algorithms on a quantum computer 105. The system 100 may comprise a primary controller 110 in communication with (e.g., configured to be communicatively coupled to) a plurality of secondary controllers 120. The system may comprise a plurality of processors 130. Although a certain number of, primary controllers 110, secondary controllers 120 and processors 130 are displayed in FIG. 1, this is merely illustrative and there may be more or fewer of each component.

The quantum computer 105 may be for example, a trapped ion quantum computer, which may be particularly suitable for large-scale quantum computing. Other types of quantum computer may be used, for example, with different physical implementations of the qubits. Any type of quantum computers may be suitable for the technologies disclosed herein. Examples of quantum computers include, but are not limited to, adiabatic quantum computers, quantum gate arrays, one-way quantum computer, topological quantum computers, quantum Turing machines, superconductor-based quantum computers, trapped ion quantum computers, optical lattices, quantum dot computers, spin-based quantum computers, spatial-based quantum computers, Loss-Di Vincenzo quantum computers, nuclear magnetic resonance (NMR) based quantum computers, liquid-NMR quantum computers, solid state NMR Kane quantum computers, electrons-on-helium quantum computers, cavity-quantum-electrodynamics based quantum computers, molecular magnet quantum computers, fullerene-based quantum computers, linear optical quantum computers, diamond-based quantum computers, Bose-Einstein condensate-based quantum computers, transistor-based quantum computers, and rare-earth-metal-ion-doped inorganic crystal based quantum computers. A quantum computer may comprise one or more of: a quantum annealer, an Ising solver, an optical parametric oscillator (OPO), or a gate model of quantum computing.

In some cases, the primary controller 110 is configured to receive a quantum algorithm. In some cases, a quantum algorithm may be implemented as a quantum circuit. A quantum algorithm may be a series of steps that can be performed on a quantum computer 105 to solve a problem. A quantum circuit may implement a set of physical operations on the state of the qubits. In some cases, the quantum algorithm may be implemented as a quantum annealing calculation. A quantum annealer may comprise qubits that carry optimization of a configuration of spins in an Ising spin model. In some cases, a quantum algorithm may be implemented by gate model quantum computer. In a gate model quantum computer, a quantum circuit may be implemented as a series of gate operations to be implemented on a set of qubits. Gate operations may comprise one qubit gate operations, such as rotation gates. A rotation gate may be Pauli X, Y, and Z gate. Gate operations may comprise two qubit gates. A two-qubit gate may couple a first qubit to a second qubit. In some cases, a quantum circuit may implement a computation to be performed on the quantum computer. In some cases, a quantum circuit may implement an error correction operation.

The primary controller 110 is configured to compile the quantum algorithm into a plurality of logical qubit functions to be executed on a plurality of logical qubits. A compiler may implement an abstract quantum circuit based on a type of quantum hardware. For example, a particular quantum hardware may comprise a finite set of native operations. For example, particular quantum hardware may implement multiple physical qubits for a single logical qubit, for example, as part of an error correction scheme. How a specific quantum algorithm is to be performed on a quantum computer 105 (and therefore how the quantum algorithm is compiled) may depend on the architecture of the quantum computer 105.

The primary controller 110 may be configured to compile the quantum algorithm based on the specific hardware, software, and/or architecture of the quantum computer 105, as well as the specifics of the quantum algorithm. For example, the primary controller 110 may receive, or have stored, quantum computer parameter data describing one or more of hardware, software, and architecture of the quantum computer 105 that the quantum algorithm is to be executed on. In other words, the primary controller 110 may have an abstracted appreciation of the whole of the quantum computer 105.

The logical qubit function relates to an overall action to be performed on one or more logical qubits. This may include (but are not restricted to) a magic state distillation, a magic state consumption, a Clifford gate application, a syndrome extraction, and a logical measure. Each of these functions may require many different quantum manipulations to be performed on the one or more logical qubits and may be achieved in a variety of different ways.

In some cases, the quantum computer is a gate model quantum computer, and the plurality of logical qubit functions may be selected from a set of operations that enable a universal set of logical gates. For example, the plurality of logical qubit functions that the primary controller 110 may compile the quantum algorithm into may constitute a set of gates to which any operation possible on a quantum computer 105 may be reduced.

In some cases, the primary controller 110 is configured to transmit an instruction to each of a plurality of secondary controllers 120. For example, each instruction may prompt execution of one of the plurality of logical qubit functions on a subset of the plurality of logical qubits associated with the secondary controller 120. In some cases, one or more instructions associated with logical qubit functions to be performed on a subset of logical qubits that relate to the secondary controller 120 are transmitted to the secondary controller 120. In some cases, the primary controller 110 may transmit many instructions to respective appropriate secondary controllers 120 for execution of the logical qubit function.

In some cases, the primary controller 110 is in communication with the plurality of secondary controllers 120. Upon compiling the quantum algorithm into a plurality of logical qubit functions, the primary/first controller may communicate with the appropriate secondary controllers 120 to execute the logical qubit functions.

In some cases, each of the secondary controllers 120 are associated with a number of logical qubits, being a subset of the plurality of logical qubits. In some case, the number of associate qubits is small relative to a total number of qubits. In some cases, a secondary/second controller may control a single logical qubit. In some cases, a single logical qubit may be implemented by many physical qubits. For example, to produce error correction, many physical qubits may produce an entity that behaves as a single logical qubit would behave in a quantum algorithm or a quantum circuit. For example, about 1, about 5, about 10, about 20, about 50, about 100, about 200, about 500, about 1000, or more physical qubits may be implemented to form a single logical qubit. In some cases, a secondary/second controller may control a plurality of logical qubits. For example, a second/secondary controller may control about 2, about 5, about 10, about 20, about 50, or more logical qubits.

The secondary controllers 120 are each responsible for the logical qubits, which may include on or more of: decoding, routing, execution of the logical qubits function, and combinations thereof on the logical qubits. Execution of the logical qubits function may comprise implementing an operation of the logical qubit within a quantum circuit or a quantum algorithm. Routing may comprise a consideration of the physical connectivity of a qubits in a quantum computer. For example, certain qubits may be connected to a subset of other qubits. Accordingly, a routing problem may comprise adapting the problem to reflect available connectivity and tunability of connectivity in the quantum hardware. By delegating some of the above tasks to secondary controllers 120 (rather than having a small number of centralized controllers), complexity introduced by scaling of the quantum computing device to a large size (e.g., a large number of qubits) may be reduced.

In some cases, the subset of logical qubits associated with each secondary controller 120 is a predetermined subset of logical qubits. This may mean that the secondary controller 120 is responsible for/associated with the logical qubit no matter where the logical qubits corresponding physical qubits are located within the quantum computer 105. This may simplifies/reduces the handoff of information between secondary controllers 120 as the logical qubit is moved around the quantum computer 105. Moving a logical qubit may comprise a physical translation in quantum computers where such an operation is physically possible. In some cases, moving a logical qubit may comprise SWAP gates.

In some cases, the subset of logical qubits associated with each secondary controller 120 are in a predetermined area (e.g., a physical location) of the quantum computer 105. This may require information to be transferred as logical qubits are passed between secondary controllers 120, but also means that information need not be transferred large distances when the logical qubit moves to an area physically distant from the secondary controller.

In some cases, alternative methods of associating secondary controllers 120 with logical qubits are possible. For example, a hybrid version could be used, where logical qubits are only re-associated should they move physically distant from the logical qubit. In other cases, the secondary controllers 120 may be specialized so that multiple secondary controllers 120 perform different tasks for similar logical qubits. In some cases, many secondary controllers 120 are each responsible for/associated with a small number of logical qubits at any given time.

The primary controller may further configured, for each of the secondary controllers 120, to assign a subset of the plurality of logical qubits to the secondary controller. In this way, the primary controller 110 may be responsible for an efficient assignment of logical qubits to secondary controllers 120 (such as to minimize the physical distancing between logical qubits and secondary controllers 120, or to ensure even distributions of logical qubits amongst secondary controllers 120). For example, the primary controller may be configured to update an assignment after a regular unit of time, after a measure of efficiency drops below are certain level, or upon an instruction from a user.

In some cases, each of the plurality of secondary controllers 120 may be configured to receive instruction(s) prompting execution of logical qubit function(s) from the primary controller 110. The instruction may be of the form of a prompt to commence a sequence on the one or more logical qubits associated with the secondary controller. The instruction may be an instruction to perform one or a number of different logical qubit functions on the logical qubit(s).

In some cases, each of the plurality of secondary controllers 120 is configured to compile the instruction into a sequence of operations, each operation to be executed on one or more of the logical qubits associated with the secondary controller. In some cases, each secondary controller 120 may interpret the instruction to determine a logical qubit function. In some cases, a secondary controller may compile a sequence of operations to be performed on the corresponding subset of logical qubits to execute the logical function.

In some cases, the secondary controller 120 may compile the instruction (e.g., the logical qubit function) into many different types of sequences of operations. A particular sequence of operations may not be important to the primary controller 110, which may be more directed to the overall execution of the quantum algorithm. In some cases, the primary controller 110 may not comprise information or data regarding the specifics of the compilation of the sequences of operations.

For example, each of the operations in the sequence of operations may describe an abstracted manipulation of the logical qubit or may be an actual manipulation to be applied to the logical qubits. The actual manipulation may include a sequence of physical operations applied to physical qubits associated with the logical qubits, such as at least one of an ion shuttling, a sympathetic cooling, a single qubit gate operation, a two-qubit gate operation, a measurement, and a real-time conditional quantum gate operation.

For example, while the logical qubit function describes a function to be performed on one or more qubits, each operation relates to the actual physical changes that need to be made to the physical qubits associated with the logical qubit to achieve an associated manipulation of the logical qubit.

As shown, one or more of the secondary controllers 120 may further comprise a memory 122. The memory 122 may be configured to store (or retrieve from an external data store) a list comprising a plurality of instructions, each having an associated sequence of operations (e.g., a sequence of operations associated with each logical qubit function prompted by instructions received from the primary controller 110. In some cases, each of the plurality of secondary controllers 120 is configured to compile the instruction into the sequence of operations based on the list. For example, the secondary controllers 120 may consult a pre-compiled list for a sequence of operations. Using a pre-compiled list, the secondary controller 120 may be able to react to circumstances of associated logical qubits faster, facilitating real-time operations (without the need to consult a centralized/primary controller 110).

In some cases, the secondary controller 120 may compile each sequence of operations individually based on contextual knowledge of the logical qubits and circumstances in the area of the quantum computer 105 associated with the logical qubits.

The secondary controller 120 may be configured to generate a plurality of control signals. Each control signal may prompt one or more of the plurality of operations to be executed on the logical qubits. The control signals may be for the direct execution of each operation or may prompt dedicated hardware and/or software to perform the operation.

As shown, the plurality of secondary controllers 120 may be further configured to transmit the control signal to one or more of a plurality of processors 130 for execution of the operation to be performed on the logical qubits.

In some examples, one or more of the plurality of secondary controllers 120 may each comprise a decoder 124. A decoder may be associated with a quantum error correction protocol. A decoder may “decode” which errors occurred on which qubits. Once identified, these errors can be tracked, and the information used to correct subsequent measurement outcomes. For example, a decoder may take in syndrome information, such as from syndrome measurements, and determine which errors have occurred. In response to the determining, a set of recovery operations may be determined. A decoder may be configured to obtain a set of check operator measurements of the logical qubits associated with the secondary controller. The set of check operator measurements may comprise syndrome measurements. A decoder may be configured to process the set of check operator measurements to determine a correction operator for removing error of the logical qubits or a monitor operator for tracking the logical qubits. A decoder may be configured to generate a plurality of control signals prompting the correction operator to be executed on the logical qubits or the monitor operator to track the logical qubits.

The round of syndrome measurements performed as part of an error correction procedure may be referred to as syndrome extraction. A syndrome extraction may be a series of physical 2-qubit interactions and measurement operations which form a portion of an error correction procedure. The measurement operations may be analyzed, and the analysis may lead to suggested corrections on a logical qubit at the physical qubit. A logical qubit function may comprise a set of operations that may be implemented by a compiler. The complier may run in conjunction with a decoder which receives the measurements and determines a set of recovery operations from the syndrome information. A particular error type may be associated with a particular set of syndrome information allowing a decoder to track a type of error. In some cases, the logical qubit function may be implemented in conjunction with classical processing and branch selection.

Systems and methods disclosed herein may be used with various decoders. Example decoders may comprise minimum-weight perfect matching, union find, tensor network decoder, belief propagation with ordered statistics decoder, maximum likelihood decoder, and look up table decoders. Examples of the minimum-weight perfect matching decoder may comprise fusion blossom or sparse blossom.

In some cases, the decoder 124 may be configured to obtain a set of check operator measurements of the logical qubits (e.g., the logical qubits associated with the secondary controller). For example, the set of check operator measurements may be a set of measurements indicating an error of the logical qubit(s), and associated physical qubits, or lack thereof. These may be obtained by the decoder 124 itself, or by appropriate dedicated hardware and/or software. The set of check operator measurements may be determined by a type of error correcting code and/or a type of quantum computer.

Various error correcting codes may be integrated with methods and systems of the present disclosure. For example, an error correcting code may be in the class of stabilizer codes. An error correcting code may be in the class of topological codes. A topological error correcting code may comprise a surface code, a colour code, a toric code, etc. For example, a colour code may comprise a Steane code, etc. Systems and methods disclosed herein may be used with various Shor style codes, for example, a Bacon-Shor code, a Calderbank-Shor-Steane code, etc. Systems and methods disclosed herein may be used with various qLDPC codes, for example, hypergraph product codes.

The set of check operator measurements may be processed to determine either (i) a correction operator for removing error of the logical qubits (such as, if an error is indicated by the check operator measurements), (ii) a monitor operator for tracking the logical qubits if no error is indicted as present or likely, or both. The decoder 124 may also be configured to generate a plurality of control signals prompting either: (i) the correction operator to be executed on the logical qubits (so as to error-correct the logical qubit), or (ii) the monitor operator to track the logical qubits, or both. The secondary controller 120 may comprise dedicated means for localized (e.g., relating to the logical qubits associated with the secondary controller) error detection and correction. As a small number of logical qubits are error detected and corrected, problems associated with the exponential rate of complexity with the number of logical qubits to track and correct may be overcome.

In some cases, the secondary/second controller 120 may also receive signal(s) containing information from the processor(s) 130, quantum-computer 105, or other down-stream hardware. Such signals may contain information about quantum-errors, qubit/ion-loss etc. Accordingly, the secondary controller may utilize such information in order to modify/change/augment the control signal(s).

In some examples, when the quantum computer 105 is a trapped ion quantum computer 105, the secondary controller 120 may be configured to monitor physical operations performed on the logical qubits associated with the secondary controller 120 in order to detect ion-loss corresponding to one of the logical qubits. That is, the secondary controller 120 may be configured to be able to monitor and detect ion loss. For example, ion loss may be detected from check measurements from an error correction code. For example, ion loss may be detected from a measurement operation on a particular ion determine whether an ion is present.

Responsive to detecting ion-loss, the secondary controller 120 may then (independently) compile a correction instruction for handling the ion-loss into a sequence of correction operations, each correction operation to be executed on the logical qubit. The secondary controller 120 generates a plurality of control signals. In some cases, each control signal may prompt one of the plurality of correction operations to be executed on the logical qubit. A correction operation on the logical qubit may comprise one or more sub-operations on the physical qubits associated with the logical qubit.

In some cases, when utilized in a trapped ion quantum computer, the secondary controller 120 may be exploited to detect and correct ion-loss associated with logical qubits to which it is responsible. This may be performed without communication with the primary controller 110. In some examples, this problem can be handled locally as it's occurrence may not be important to the overall execution of the quantum algorithm.

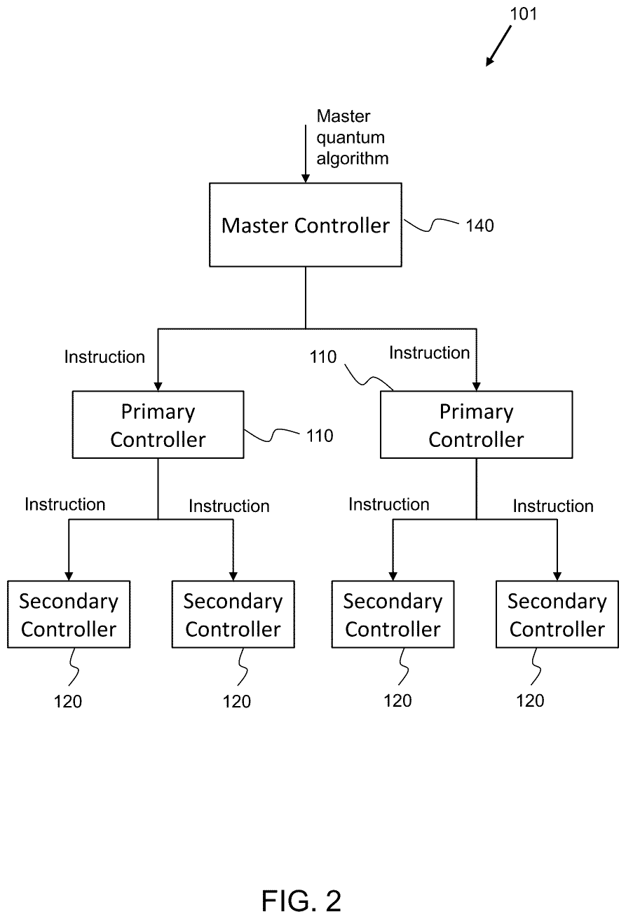

FIG. 2 presents a further aspect of a system 101 controlling the execution of quantum algorithms on a quantum computer 105 in accordance with the present disclosure. The function of the primary and secondary controllers 120 of FIG. 2 may be similar to those described in relation to FIG. 1, and therefore further description of their function is omitted here for the sake of brevity. The system of FIG. 2 may comprise an example, variation, or embodiment of the system of FIG. 1.

The system 101 depicted in FIG. 2 further comprises a master controller 140 in communication with a plurality of the primary controllers 110. The system 101 may comprise a plurality of primary controllers 110 (each similar to the primary controllers 110 described above), in communication to the master controller 140.

In some cases, when the master controller 140 is provided, it may be configured to obtain a master quantum algorithm. The master quantum algorithm may be considered a quantum algorithm that may be split up into various other quantum algorithms. In other words, the master quantum algorithm may be a large algorithm.

The master controller 140 may be configured to divide the master quantum algorithm into a plurality of quantum algorithms, each quantum algorithm assigned to a different primary controller 110. The master quantum algorithm may be segmented into individual quantum algorithms that may be performed on different parts of the quantum computer 105. For example, when various portions of a quantum algorithm are capable of being run in parallel, each primary controller may work with one of the plurality of parallelizable portions.

In some cases, the master controller 140 may be configured to transmit an instruction to each of the plurality of primary controllers 110, each instruction prompting execution of one of the quantum algorithms on the plurality of logical qubits.

FIG. 2 presents an example of a way in which control of a quantum computer 105 in executing a quantum algorithm can be modularized and performed in a hierarchical nature. The secondary controllers 120 may be responsible for prompting actual operations to be performed on the logical qubits, the primary controllers 110 for compiling a quantum algorithm into a plurality of logical qubit functions, and the master quantum algorithm for providing manageable quantum algorithms to the primary controller 110. With this hierarchical approach, management of a quantum computer 105 during an execution of a quantum algorithm may be simplified and may help to avoid problems involved with scaling.

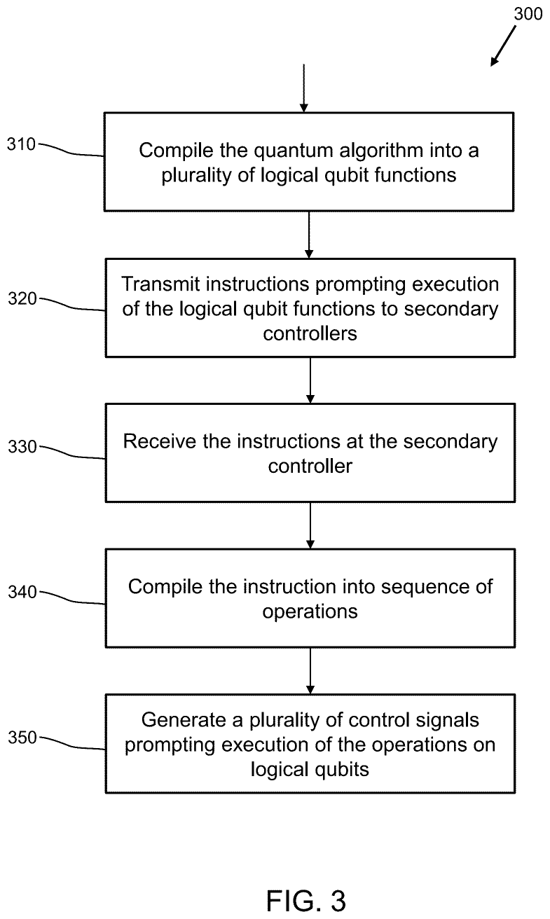

FIG. 3 presents a flow diagram including operations in a method 300. In some cases, the method 300 is for controlling execution of a quantum algorithm on a quantum computer 105.

At an operation 310, the quantum algorithm may be compiled (by a primary controller 110) into a plurality of logical qubit functions to be executed on a plurality of logical qubits.

At an operation 320, instructions may be transmitted (by the primary controller 110) to each of a plurality of secondary controllers 120, each instruction prompting execution of one of the plurality of logical qubit functions on a subset of the plurality of logical qubits associated with the secondary controller.

At an operation 330, a respective instruction may be received (by each secondary controller prompting execution of the logical qubit function from the primary controller 110.

At an operation 340, the instruction may be compiled (by the secondary controller) into a sequence of operations, each operation to be executed on one or more of the logical qubits associated with the secondary controller.

At an operation 350, a plurality of control signals may be generated (by the secondary controller), each control signal prompting one of the plurality of operations to be executed on the logical qubits.

Additionally, it should be noted that the method 300 may comprise additional steps. For example, there may also be a step of retrieving signals by the secondary controllers from processors and/or the quantum computer itself. The signals may contain information such as ion-loss or quantum error information, which can then be used by the secondary controller to modify one or more of the plurality of control signals. In other words, the secondary controller may receive information from locations other than the primary controller, which may be used to inform the choice of control signals.

Accordingly, a method for controlling execution of a quantum algorithm on a quantum computer 105 is provided in which responsibilities of prompting execution of specific logical qubit functions are handled by (decentralized, localized) secondary controllers. A (central) primary controller 110 may handle the compiling of the quantum algorithm, and the transmission of such signals to appropriate secondary controllers 120. Put another way, in this method the primary controller 110 may be concerned with the (abstracted) execution of the quantum algorithm, while the secondary controllers 120 are concerned with how the algorithm is actually executed by the logical qubits (including decoding, routing, etc.).

The systems for controlling execution of a quantum algorithm on a quantum computer of the present disclosure may comprise one or more digital computers. The digital computers may be a digital computer of various types, such as, for example, a digital computer as described elsewhere herein. Each of the primary/first controller and the secondary/second controllers may be or comprise a digital computer. In some cases, a master controller may be a digital computer. The digital computer may comprise an associate processing device (e.g., a processor) and an associated memory. The at least one processor can comprise at least one field-programmable gate array (FPGA), application-specific integrated circuit (ASIC), central processing unit (CPU), graphics processing unit (GPU), tensor processing unit (TPU), tensor streaming processor (TSP), or the like, or any combination thereof. The at least one memory may comprise a computer program executable by the processing device which may be configured to communicate between digital computers of the present disclosure, perform various compiling operations, direct instructions, receive instructions, or the like, or any combination thereof. The at least one memory may comprise a computer program executable by the processing device which may be configured to compile a quantum algorithm into instructions, to compile an instruction into a sequence of operation, to store the result in a database, or the like, or any combination thereof.

Each component of the system (e.g., the hardware) may be used as part of the system to execute a whole method, or any portion thereof, alone or in combination with other components (e.g., other hardware). In some cases, the components may be used for performing a quantum algorithm.

The various components of the system may be connected locally or over a network. The various components can have network communication devices. The network communication devices can enable the various components of the system to communicate with each other and with any number of user devices, over a network. The network can be a wired or wireless network. For example, the network can be a fiber optic network, Ethernet® network, a satellite network, a cellular network, a Wi-Fi® network, a Bluetooth® network, or the like. In other implementations, the computational platform, the database, and/or digital computer can be several distributed computational platforms that are accessible through the Internet. Such computational platforms may be considered cloud computing devices. In some cases, one or more controllers of the present disclosure may be located in the cloud.

In some cases, the system or controlling execution of a quantum algorithm on a quantum computer can communicate with one or more remote computer systems through the network. For instance, the digital computer system can communicate with a remote computer system of a user.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A system for controlling execution of a quantum algorithm on a quantum computer, the system comprising:
a first controller in communication with a plurality of second controllers, wherein the first controller is configured to transmit a set of instructions to the plurality of second controllers,
wherein the set of instructions comprises a portion of a quantum algorithm to be implemented on one or more logical qubits associated with the plurality of second controllers,
wherein an instruction within the set of instructions is configured to direct a second controller of the plurality of second controllers to compile the instruction into a sequence of operations to be executed on a plurality of physical qubits.

2. The system of claim 1, wherein the second controller is configured to transmit a control signal to the one or more logical qubits.

3. The system of claim 2, wherein an operation of the sequence of operations comprises a qubit movement operation, and wherein the control signal is configured to execute the qubit movement operation on a physical qubit of the plurality of physical qubits.

4. The system of claim 1, wherein the second controller of the plurality of second controllers is configured to control a physical area of the quantum computer, and wherein an operation of the sequence of operations is configured to move a logical qubit of the one or more logical qubits across the physical area of the quantum computer.

5. The system of claim 4, wherein an assignment of the logical qubit of the one or more logical qubits to the second controller of the plurality of second controllers is based on the physical area of the quantum computer.

6. The system of claim 5, wherein the physical area comprises a boundary, and wherein the quantum computer comprises a plurality of physical areas.

7. The system of claim 1, wherein the first controller is configured to compile the quantum algorithm into the set of instructions.

8. The system of claim 7, wherein the set of instructions is configured to prompt a set of logical qubit functions, and wherein the set of logical qubit functions comprises one or more of: a set of operations that enable a universal set of logical gates, a set of operations comprising a magic state distillation, a magic state consumption, a Clifford gate application, a syndrome extraction, or a logical measure.

9. The system of claim 1, wherein the second controller of the plurality of second controllers is configured to control at least one logical qubit of the one or more logical qubits.

10. The system of claim 9, wherein the first controller is configured to generate an assignment of the at least one logical qubit of the one or more logical qubits to the second controller of the plurality of second controllers.

11. The system of claim 10, wherein the assignment is based at least in part on a distance between the at least one logical qubit of the one or more logical qubits and the second controller of the plurality of second controllers.

12. The system of claim 1, wherein the second controller of the plurality of second controllers is configured to locally detect and correct errors within the one or more logical qubits.

13. The system of claim 1, wherein the second controller of the plurality of second controllers comprises or is associated with hardware, wherein the hardware is configured to provide the second controller with measurements of the one or more logical qubits.

14. The system of claim 13, wherein the hardware is configured to obtain the measurements directly from the one or more logical qubits.

15. The system of claim 14, wherein the hardware is associated with a decoder.

16. The system of claim 15, wherein the decoder is configured to process the measurements to determine whether there is an error or lack thereof in the one or more logical qubits or in a physical qubit of a logical qubit of the one or more logical qubits.

17. The system of claim 16, wherein upon detection of an error, the decoder is configured to generate a plurality of control signals to correct the error.

18. The system of claim 1, wherein the second controller of the plurality of second controllers is configured to receive real time information from a source other than the first controller, and wherein the second controller is configured to compile the instruction into the sequence of operations based on the real time information.

19. The system of claim 1, wherein an operation in the sequence of operations comprises a qubit manipulation.

20. The system of claim 19, wherein the qubit manipulation comprises a physical operation comprising one or more of: a qubit shuttling, a sympathetic cooling, a single qubit gate operation, a two-qubit gate operation, a measurement, or a real time conditional quantum gate operation.
